(19) United States
(12) Patent Application Publication
(10) Pub. No.: US 2022/0406138 A1
(43) Pub. Date: Dec. 22, 2022

(54) METHODS, APPARATUSES, DEVICES, AND STORAGE MEDIA FOR CONTROLLING GAME STATES

(71) Applicant: SENSETIME INTERNATIONAL PTE. LTD., Singapore (SG)

(72) Inventors: Xinxin WANG, Singapore (SG); Bing SUN, Singapore (SG)

(21) Appl. No.: 17/364,334

(22) Filed: Jun. 30, 2021

Related U.S. Application Data
(63) Continuation of application No. PCT/IB2021/055674, filed on Jun. 25, 2021.

(30) Foreign Application Priority Data
Jun. 21, 2021 (SG) 10202106746V

(51) Int. Cl. G07F 17/32

(52) U.S. Cl. CPC G07F 17/3262; G07F 17/3293

(57) ABSTRACT

The present disclosure relates to a method, an apparatus, a device, and a storage medium for controlling game states. The method includes: determining, in response to that an interface call instruction is acquired, a target interface from a plurality of preset interfaces according to the interface call instruction, wherein each of the plurality of interfaces is encapsulated with a state switching condition; acquiring a current state of the game; and transferring the current state to the target interface, and switching the game to a target state according to a state switching condition encapsulated in the target interface and corresponding to the current state by calling the target interface.

### CROSS REFERENCE TO RELATED APPLICATION

This application is a continuation application of International Application No. PCT/IB2021/055674 entitled “METHODS, APPARATUSES, DEVICES, AND STORAGE MEDIA FOR CONTROLLING GAME STATES” filed on Jun. 25, 2021, which claims priority to Singaporean Patent Application No. 10202106746V entitled “METHODS, APPARATUSES, DEVICES, AND STORAGE MEDIA FOR CONTROLLING GAME STATES” and filed on Jun. 21, 2021, the entire contents of which are incorporated herein by reference.

### TECHNICAL FIELD

The present disclosure relates to the field of computer vision technologies, and in particular, to a method, an apparatus, a device, and a storage medium for controlling game states.

### BACKGROUND

A complete game may usually include various different states of the game. During the game, it is necessary to switch the game to corresponding states according to the progress of the game. At present, a service system automatically controls the states of the game. However, erroneous control such as incorrect switching may occur during automatic control, and at present, such erroneous control cannot be effectively adjusted.

### SUMMARY

The present disclosure provides a method, an apparatus, a device and a storage medium for controlling game states to resolve the deficiencies in the related art.

According to a first aspect of the embodiments of the present disclosure, a method of controlling game states is provided, including:

determining, in response to that an interface call instruction is acquired, a target interface from a plurality of preset interfaces according to the interface call instruction, wherein each of the plurality of interfaces is encapsulated with a state switching condition;

acquiring a current state of the game; and

transferring the current state to the target interface, and switching the game to a target state according to a state switching condition encapsulated in the target interface and corresponding to the current state by calling the target interface.

In an embodiment, the method further includes:

acquiring a desktop image of the game in the current state;

detecting state information of one or more desktop elements of the game according to the desktop image; and

transferring the state information to the target interface; and

switching the game to a target state according to a state switching condition encapsulated in the target interface and corresponding to the current state by calling the target interface includes:

switching the game to a target state according to the state switching condition encapsulated in the target interface and corresponding to the current state together with the state information.

In an embodiment, the desktop elements include a marker placement region and an item operation region, the marker placement region is used for placing a preset marker before the game is started, and the item operation region is used for operating a game item if the game is in an item operation state;

determining the target interface from the plurality of preset interfaces according to the interface call instruction includes:

determining, if the interface call instruction is used for instructing to invalidate a current round of the game and start a next round of the game, that the target interface is an invalidation interface; and

switching the game to a target state according to the state switching condition encapsulated in the target interface and corresponding to the current state together with the state information includes:

determining, if the target interface is the invalidation interface and the current state is a paused state, whether the preset marker exists in the marker placement region and whether the item operation region is in an empty state according to the state information; and

switching, if the preset marker exists in the marker placement region and the item operation region is in the empty state, the game to a prop operation state.

In an embodiment, the desktop element includes a marker placement region, an item operation region, and a game item, the marker placement region is used for placing a preset marker before the game is started, and the item operation region is used for operating the game item if the game is in an item operation state;

determining the target interface from the plurality of preset interfaces according to the interface call instruction includes:

determining, if the interface call instruction is used for instructing to restore a prop operation state, an item operation state, or a result processing state of a current round of the game, that the target interface is a restoration interface; and

switching the game to a target state according to the state switching condition encapsulated in the target interface and corresponding to the current state together with the state information includes:

determining, if the target interface is the restoration interface and the current state is a paused state, whether the preset marker exists in the marker placement region and whether the item operation region is in an empty state according to the state information;

switching, if the preset marker exists in the marker placement region and the item operation region is in the empty state, the game to the prop operation state; and

switching, if the preset marker exists in the marker placement region and the game item exists in the item operation region, the game to the item operation state or the result processing state according to state information of the game item in the item operation region.

In an embodiment, the state information of the game item includes a quantity of the game items; and

switching the game to the item operation state or the result processing state according to state information of the game item in the item operation region includes:

switching, if the quantity of the game items in the item operation region is less than a preset quantity threshold, the game to the item operation state.

In an embodiment, the state information of the game item further includes state information of an identification surface of the game item; and

switching the game to the item operation state or the result processing state according to state information of the game item in the item operation region further includes:

determining, if the quantity of the game items is greater than or equal to the preset quantity threshold, whether the identification surface of each of the game items in the item operation region is a visible state or a hidden state according to the state information of the identification surface of each of the game items in the item operation region;

if the identification surface of each game item is in the visible state, acquiring the identifier information of each of the game items in the visible state, and switching, if a game result is generated according to the identifier information, the game to the result processing state; and

switching, if the identification surface of at least one of the game items is in the hidden state, the game to the item operation state.

In an embodiment, the item operation region includes at least two item subregions;

determining, according to the state information, whether the item operation region is in an empty state includes:

determining, according to the state information, whether each of the item subregions of the item operation region is in the empty state; and

switching the game to a target state according to the state switching condition encapsulated in the target interface and corresponding to the current state together with the state information further includes:

keeping, if a relationship between quantities of items in the item subregions of the item operation region does not satisfy a preset relationship, the game in the paused state.

In an embodiment, the game item is a playing card.

In an embodiment, acquiring a desktop image of the game in the current state includes:

acquiring the desktop image of the game in the current state based on a video stream of a desktop, where the video stream includes video streams synchronously captured at a plurality of view angles of the desktop, the plurality of view angles includes a side view angle and a top view angle, and the side view angle includes at least one of a left side view angle and a right side view angle.

In an embodiment, determining the target interface from the plurality of preset interfaces includes:

if the interface call instruction is used for instructing to end the game, determining that the target interface is an idle interface;

if the interface call instruction is used for instructing to start a round of game, determining that the target interface is a prop interface;

if the interface call instruction is used for instructing to pause the game, determining that the target interface is a pause interface; and

if the interface call instruction is used for instructing to reset the game, determining that the target interface is a resetting interface; and

In an embodiment, switching the game to a target state according to a state switching condition encapsulated in the target interface and corresponding to the current state by calling the target interface includes:

if the target interface is the idle interface and the current state is a prop operation state, switching the game to an idle state;

if the target interface is the prop interface and the current state is the idle state, switching the game to the prop operation state;

if the target interface is the pause interface and the current state is the prop operation state or an item operation state, switching the game to a paused state;

if the target interface is the resetting interface and the current state is in any state, switching the game to the idle state; and

if the target interface is any interface and the current state is in a blank state, switching the game to the idle state.

According to a second aspect of the embodiments of the present disclosure, an apparatus for controlling game states is provided, including:

a target module, configured to: determine, in response to that an interface call instruction is acquired, a target interface from a plurality of preset interfaces according to the interface call instruction, wherein each of the plurality of interfaces is encapsulated with a state switching condition;

a state module, configured to acquire a current state of the game; and

a switching module, configured to: transfer he current state to the target interface, and switch the game to a target state according to a state switching condition encapsulated in the target interface and corresponding to the current state by calling the target interface.

In an embodiment, the apparatus further includes:

an image module, configured to acquire a desktop image of the game in the current state;

a detection module, configured to detect state information of one or more desktop elements of the game according to the desktop image; and

a transfer module, configured to transfer the state information to the target interface; and

when the switching module is configured to switch the game to a target state according to a state switching condition encapsulated in the target interface and corresponding to the current state by calling the target interface, the switching module is specifically configured to:

switch the game to a target state according to the state switching condition encapsulated in the target interface and corresponding to the current state together with the state information.

In an embodiment, the desktop elements include a marker placement region and an item operation region, the marker placement region is used for placing a preset marker before the game is started, and the item operation region is used for operating a game item if the game is in an item operation state;

when the target module is configured to determine a target interface from the plurality of preset interfaces, the target module is specifically configured to:

if the interface call instruction is used for instructing to invalidate a current round of the game and start a next round of the game, determine that the target interface is an invalidation interface; and

when the switching module is configured to switch the game to a target state according to the state switching condition encapsulated in the target interface and corresponding to the current state together with the state information, the switching module is specifically configured to:

determine, if the target interface is the invalidation interface and the current state is a paused state, whether the preset marker exists in the marker placement region and whether the item operation region is in an empty state according to the state information; and

switch, if the preset marker exists in the marker placement region and the item operation region is in the empty state, the game to a prop operation state.

In an embodiment, the desktop elements include a marker placement region, an item operation region, and a game item, the marker placement region is used for placing a preset marker before the game is started, and the game item operation region is used for operating the game item if the game is in an item operation state;

when the target module is configured to determine a target interface from the plurality of preset interfaces, the target module is specifically configured to:

determine, if the interface call instruction is used for instructing to restore a prop operation state, an item operation state, or a result processing state of a current round of the game, that the target interface is a reset interface; and

when the switching module is configured to switch the game to a target state according to the state switching condition encapsulated in the target interface and corresponding to the current state together with the state information, the switching module is specifically configured to:

determine, if the target interface is the restoration interface and the current state is a paused state, whether the preset marker exists in the marker placement region and whether the item operation region is in an empty state according to the state information; and

switch, if the preset marker exists in the marker placement region and the item operation region is in the empty state, the game to the prop operation state; and

switch, if the preset marker exists in the marker placement region and the game item exists in the item operation region, the game to the item operation state or the result processing state according to state information of the game item in the item operation region.

In an embodiment, the state information of the game item includes a quantity of the game items; and

when the switching module is configured to switch the game to the item operation state or the result processing state according to state information of the game item in the item operation region, the switching module is specifically configured to:

switch, if the quantity of the game items in the item operation region is less than a preset quantity threshold, the game to the item operation state.

In an embodiment, the state information of the game item further includes state information of an identification surface of the game item; and

when the switching module is configured to switch the game to the item operation state or the result processing state according to state information of the game item in the item operation region, the switching module is specifically configured to:

determine, if the quantity of the game items is greater than or equal to the preset quantity threshold, whether the identification surface of each of plurality of game items in the item operation region is a visible state or a hidden state according to the state information of the identification surface of each of the game items in the item operation region;

if the identification surface of each game item is in the visible state, acquire the identifier information of each of the game items, and switch, if a game result is generated according to the identifier information, the game to the result processing state; and

switch, if the identification surface of at least one of the game items is in the hidden state, the game to the item operation state.

In an embodiment, the item operation region includes at least two item subregions;

when the switching module is configured to determine, according to the state information, whether the item operation region is in an empty state, the switching module is specifically configured to:

determine, according to the state information, whether each item subregion of the item operation region is in the empty state; and

when the switching module is configured to switch the game to a target state according to the state switching condition encapsulated in the target interface and corresponding to the current state together with the state information, the switching module is further specifically configured to:

keeping, if a relationship between quantities of items in the item subregions of the item operation region does not satisfy a preset relationship, the game in the paused state.

In an embodiment, when the target module is configured to determine the target interface from the plurality of preset interfaces according to the interface call instruction, the target module is specifically configured to:

if the interface call instruction is used for instructing to end the game, determine that the target interface is an idle interface;

if the interface call instruction is used for instructing to start a round of game, determine that the target interface is a prop interface;

if the interface call instruction is used for instructing to pause the game, determine that the target interface is a pause interface; and

if the interface call instruction is used for instructing to reset the game, determine that the target interface is a resetting interface.

In an embodiment, when the switching module is configured to switch the game to a target state according to a state switching condition encapsulated in the target interface and corresponding to the current state by calling the target interface, the switching module is specifically configured to:

if the target interface is the idle interface and the current state is a prop operation state, switch the game to an idle state;

if the target interface is the prop interface and the current state is the idle state, switch the game to the prop operation state;

if the target interface is the pause interface and the current state is the prop operation state or an item operation state, switch the game to a paused state;

if the target interface is the resetting interface and the current state is in any state, switch the game to the idle state; and

if the target interface is any interface and the current state is in a blank state, switch the game to the idle state.

According to a third aspect of the embodiments of the present disclosure, an electronic device is provided, including a memory and a processor, where the memory is configured to store computer instructions capable of being run on the processor, and the processor implements the method according to the first aspect when executing the computer instructions.

According to a fourth aspect of the embodiments of the present disclosure, a computer-readable storage medium is provided, storing a computer program, where steps of the method according to the first aspect are implemented when the program is executed by a processor.

It can be known according to the above embodiments that if an interface call instruction is acquired, a target interface may be determined from a plurality of preset interfaces according to the interface call instruction, a current state of a game is acquired, and then the game can be switched to a target state according to a state switching condition encapsulated in the target interface which corresponds to the current state. Because the interface call instruction may be generated based on an operation of a user, the game may be switched to different states by using corresponding interface call instructions, so that the state of the game can be effectively controlled even if erroneous control occurs in automatic control or during debugging and maintenance, thereby improving the accuracy of switching the state of the game, and helping to ensure normal execution of the game.

It should be understood that the foregoing general description and the following detailed description are merely exemplary and explanatory, and cannot limit the present disclosure.

### BRIEF DESCRIPTION OF THE DRAWINGS

The accompanying drawings herein are incorporated in and constitute a part of the specification, illustrate embodiments of the present disclosure, and are used to explain the principle of the present disclosure together with the specification.

FIG. 1 is a flowchart of a method for controlling game states according to an embodiment of the present disclosure;

FIG. 2 is a schematic structural diagram of an apparatus for controlling game states according to an embodiment of the present disclosure; and

FIG. 3 is a schematic structural diagram of an electronic device according to an embodiment of the present disclosure.

### DETAILED DESCRIPTION OF THE EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. Implementations described in the following exemplary embodiments do not represent all implementations consistent with the present disclosure. On the contrary, the implementations are merely examples of an apparatus and a method that are consistent with some aspects of the present disclosure described in detail in claims.

The terms used in the present disclosure are merely for the purpose of illustrating specific embodiments, and are not intended to limit the present disclosure. The terms “a,” “said” and “the” of singular forms used in the appended claims of the present disclosure are also intended to include plural forms, unless otherwise specified in the context clearly. It should be further understood that the term “and/or” used herein indicates and includes any or all possible combinations of one or more associated listed props.

It should be understood that although the terms such as “first,” “second,” and “third,” may be used in the present disclosure to describe various information, the information should not be limited to these terms. These terms are merely used to distinguish between information of the same type. For example, without departing from the scope of the present disclosure, first information may also be referred to as second information, and similarly, second information may also be referred to as first information. Depending on the context, for example, the word “if” used herein may be interpreted as “while” or “when,” or “in response to determination.”

A complete game may usually include various different states of the game. During the game, it is expected to switch to corresponding states of the game according to game progresses. For example, a desktop card game may usually include states such as an empty state, an idle state, a prop operation state, an item operation state, a result processing state, and a paused state. The prop operation state is used as an example. In the prop operation state, one or more game objects (also referred to as players) participating in a game may place props such as game coins in a prop region. The type and quantity of props, a subregion of the prop region, or the like may represent the degree of participation of a player. The item operation state is then used as an example. After plyers all complete operations on props, a dealer being an operation object (also referred to as an operator) participating in the game may deal cards.

At present, a service system automatically controls switching of states of a game, for example, may implement switching of different states of the game in an entire game process according to detection in regions (for example, a game region, and a prop region), to implement automatic detection and control of the game process. However, during automatic control, there is a phenomenon of erroneous control such as incorrect switching, for example, a misoperation triggered by a misoperation of an operator such as a dealer or a misoperation of a player. In addition, in a maintenance and debugging stage of the service system, it is also expected to switch to a predetermined state according to a debugging requirement or the like. The foregoing misoperation cannot be adjusted in automatic control, and the debugging requirement cannot be satisfied, which greatly reduces the accuracy of controlling game states, and adversely affects normal execution of the game.

Based on this, according to a first aspect, at least one embodiment of the present disclosure provides a method for controlling game states, FIG. 1 shows a procedure of the method, including step S101 to step S103.

The method may be performed by an electronic device such as a terminal device or a server. The terminal device may be user equipment (UE), a mobile device, a user terminal, a terminal, a cellular phone, a cordless phone, a personal digital assistant (PDA), a handheld device, a computing device, an in-vehicle device, a wearable device, or the like. The method may be implemented by a processor invoking computer-readable instructions stored in a memory. Alternatively, a server may perform the method. The server may be a local server, a cloud server, or the like.

Step S101: Determining, in response to that an interface call instruction is acquired, a target interface from a plurality of preset interfaces according to the interface call instruction, wherein each of the plurality of interfaces is encapsulated with a state switching condition.

The interface call instruction may be generated based on an operation of a user. A specific operation manner is not limited. For example, the user may use a client device to perform an operation to generate the interface call instruction, and an operation process of the user includes selecting or inputting the interface identifier. The interface identifier may use various different forms. This is not limited in this embodiment. For example, the interface identifier may use a name of an interface or a sequence number of an interface. Optionally, the user may operate a preset specific button to generate the interface call instruction. Each specific button corresponds to a specific interface identifier.

The target interface may be called by using a representational state transfer application programming interface (RESTful API) provided by a service system. A plurality of interfaces may include interfaces such as an idle interface, a prop interface, a pause interface, an invalidation interface, a restoration interface, and a resetting interface. An independent state switching condition is encapsulated in each interface. The state switching condition is a game state switching logic of the interface in different states of the game. For example, the state switching condition may be a mapping table, including a mapping relationship between a combination of an interface and a current state and a target state. Therefore, each interface is used for switching a state of a game according to a state switching condition encapsulated in the interface when the interface is called.

In addition, there is a mapping relationship between each interface and a call instruction. For example, if the interface call instruction is used for instructing to end the game, it may be determined that the target interface is the idle interface. In another example, if the interface call instruction is used for instructing to start a round of game, it may be determined that the target interface is the prop interface. In another example, if the interface call instruction is used for instructing to pause the game, it may be determined that the target interface is the pause interface. In another example, if the interface call instruction is used for instructing to reset the game, it may be determined that the target interface is the resetting interface. Through recognition of indication content of the interface call instruction, the target interface may be determined on purpose, so that the accuracy of determining a target interface is improved, thereby improving the accuracy of subsequent switching of the state of the game.

Step S102: Acquiring a current state of the game.

The state of the game includes a blank state, an idle state, a prop operation state, an item operation state, a result processing state, and a paused state. The idle state is a state when the service system is just powered on. The prop operation state is a state when a player operates a prop. Therefore, when a prop such as a game coin appears in a prop region, the state is automatically switched to the prop operation state. The item operation state is a state when an operator such as a dealer operates a game item. Therefore, when a game item such as a playing card appears in a game region, the state is automatically switched to the item operation state. The result processing state is a state in which based on the game item a game result can be obtained. Therefore, when the game item in the game region satisfies a condition of acquiring the game result, the state is automatically switched to the result processing state. The paused state is a state when the game is paused, that is, a state in which the game cannot execute normally. Therefore, when a case such as a misoperation of a player or an operator occurs, the state is automatically switched to the paused state. The blank state is a state different from any foregoing state.

It should be noted that, in both an automatic control process of the state of the game described above and a manual control process by applying the method provided in the present disclosure or another method, the service system can record a game state switching process in real time. That is, the service system records a game state of the game. Therefore, in this step, the game state of the game can be directly acquired from the service system. It may be understood that this step is not limited by the foregoing manner of acquiring the state of the game, and another manner may be used to acquire the game state of the game.

Step S103: Transferring the current state to the target interface, and switching the game to a target state according to a state switching condition encapsulated in the target interface and corresponding to the current state by calling the target interface.

In this step, a target game state may be first determined according to a state switching condition corresponding to the current state in state switching conditions of the target interface. The game is then accurately switched to the target game state. For example, the determined target game state is a paused state, and the game is switched to the paused state.

In a possible embodiment, if the target interface is the idle interface and the current state is a prop operation state, in this step, it is first determined that the target game state is the idle state, and the game is then switched to the idle state. In addition, when the target interface is the idle interface and the current state is a state other than the prop operation state, the game is kept unchanged in this step.

In another possible embodiment, if the target interface is the prop interface and the game is in the idle state, in this step, it is first determined that the target game state is the prop operation state, and the game is then switched to the prop operation state. In addition, when the target interface is the prop interface and the current state is a state other than the idle state, the game is kept unchanged in this step.

In another possible embodiment, if the target interface is the pause interface and the game is in the prop operation state or the item operation state, in this step, it is first determined that the target game state is a paused state, and the game is then switched to the paused state. In addition, if the target interface is the pause interface and the current state is a state other than the prop operation state and the item operation state, the game is kept unchanged in this step.

In a possible embodiment, if the target interface is the resetting interface additionally, and the game is currently in any state of the game, in this step, it is determined that the target game state is the idle state, the game is then switched to the idle state.

In a possible embodiment, no matter what the target interface is, provided that the current state is the blank state, in this step, it is determined that the target game state is the idle state, the game is then switched to the idle state.

It can be known according to the above embodiments that if an interface call instruction is acquired, a target interface may be determined from a plurality of preset interfaces according to an interface identifier in the interface call instruction, a current state that a game is in is acquired, and a state of the game is finally switched according to a state switching condition encapsulated in the target interface and corresponding to the current state. Because the interface call instruction may be generated based on an operation of a user, different states of the game may be switched by using different interface call instructions, so that the state of the game can be automatically switched conveniently and rapidly by using a call interface. If erroneous control occurs during automatic control or during debugging and maintenance, the state of the game is controlled by using a call interface, thereby improving the accuracy of switching the state of the game, and helping to ensure normal execution of the game.

In some embodiments of the disclosure, in addition to acquiring the target interface and the current state of the game, a desktop image of the game in the current state may be further acquired, state information of a desktop element of the game according to the desktop image is detected, and the state information is transferred to the target interface.

The desktop element may include a region, an object, and/or the like on a desktop of the game. For example, the desktop element may include a marker placement region, an item operation region, and a game item. The marker placement region is used for placing a preset marker before the game is started. The game item operation region is used for operating the game item if the game is in an item operation state. The marker may be a sign card, for example, an insurance indication card. The insurance indication card is placed in an item placement region in the item operation state, and is used for instructing to allow an object participating in a game to operate a prop such as a game coin, for example, to add or reduce game coins. The marker has a fixed placement region, that is, the marker placement region. The game item is used for acquiring a game result, for example, a playing card in a card game. The item has a fixed placement region, that is, the item operation region. It should be noted that the marker placement region and the item operation region may be independent from each other, contain each other or have an intersection. For example, a placement region of an insurance indication card is in the item operation region.

A desktop image of the game in the current state may be acquired based on a video stream of the desktop. The video stream includes video streams synchronously captured at a plurality of view angles of the desktop. The plurality of view angles includes a side view angle and a top view angle. The side view angle includes a left side view angle and/or a right side view angle. In a possible implementation, the video stream of the desktop may be acquired by using a preset video capture device. For example, the video capture device may be installed above a desktop of a desktop card game, to acquire a video stream of a marker region. It may be understood that the video stream of the marker region may be acquired in various manners of implementation. The foregoing example does not constitute a limitation to the manner of acquisition.

There may be various manners of implementation for specific implementation of how to detect the desktop element of the desktop image and determine state information of the desktop element. This is not limited in this embodiment. In a possible implementation, a recognition network that may be configured to recognize the desktop element in the desktop image may be acquired through pre-training based on a machine learning model or a neural network model, so that when the desktop element in the desktop needs to be detected, the desktop image is detected by using the trained recognition network.

Based on the foregoing detection of the state information of the desktop elements, when the game is switched to a target state according to a state switching condition encapsulated in the target interface and corresponding to the current state by calling the target interface, the game may be switched to the target state according to the state switching condition encapsulated in the target interface and corresponding to the current state together with the state information. When the target interface described in the foregoing embodiments is an idle interface, a prop interface, a pause interface, or a resetting interface, the state of the game is not switched based on the state information of the desktop element. A case of switching the state of the game based on the desktop element is described below by using an invalidation interface and a restoration interface as examples.

If the interface call instruction is used for instructing to invalidate a current game and start a next round of game, it is determined that the target interface is an invalidation interface. During switching of a state of a game, if the target interface is the invalidation interface and the current state is a paused state, it is first determined according to the state information whether the preset marker exists in the marker placement region and whether the item operation region is in an empty state. If the preset marker exists in the marker placement region and the item operation region is in the empty state, the game is switched to a prop operation state.

The paused state may be triggered by a misoperation of an operator or a misoperation of a player. Therefore, after an error caused by the foregoing misoperation is eliminated, the invalidation interface may then be called by using the interface call instruction to start a next round of game, that is, to restore a normal state. If the marker exists in the marker placement region and the item operation region is in the empty state (that is, there is no game item in the item operation region), it represents that no misoperation exists. Therefore, the prop operation state may be restored. In the prop operation state, a player may operate props (for example, add props or reduce props), an operator such as a dealer may further operate an item, to switch the game to the item operation state.

Through the detection of states of desktop elements in the marker placement region and the item operation region, it may be acquired whether the preset marker exists in the marker placement region and whether a game item exists in the item operation region, so that it may be determined, according to a detection result, whether an error caused by a misoperation exists. If no error exists, it indicates that the error caused by the misoperation has been eliminated, that is, the normal state is restored. Therefore, a next round of game may be started. Based on the state switching condition corresponding to the current state, reference for the states of the preset marker and the game item is further added, thereby improving the accuracy of controlling game states.

If the interface call instruction is used for instructing to restore a prop operation state, an item operation state, or a result processing state of a current round of game, it is determined that the target interface is a restoration interface. During switching of a state of a game, if the target interface is the restoration interface and the current state is a paused state, it is first determined according to the state information whether the preset marker exists in the marker placement region and whether the item operation region is in an empty state. If the preset marker exists in the marker placement region and the item operation region is in the empty state, the game is switched to the prop operation state. If the preset marker exists in the marker placement region and the game item exists in the item operation region, the game is switched to the item operation state or the result processing state according to state information of the game item in the item operation region.

The paused state may be triggered by a misoperation of an operator or a misoperation of a player. Therefore, after an error caused by the foregoing misoperation is eliminated, the restoration interface may then be called by using the interface call instruction to restore a normal state. Specifically, which state is to be restored is determined by using the states of the desktop elements in the marker placement region and the item operation region. That is, the game is switched to a state of which requirements are satisfied by cases of the two regions.

If the preset marker exists in the marker placement region and the item operation region is in the empty state (that is, there is no game item in an item placement region), it represents that no misoperation exists, a game item has not been operated by an operator. Therefore, the prop operation state may be restored. In the prop operation state, a player may operate props (for example, add props or reduce props), and an operator such as a dealer may further operate a game item to switch the game to the item operation state.

If the preset marker exists in the marker placement region and a game item exists in the item operation region, it represents that the game item has been operated by an operator. Whether a state that the item has been operated satisfies requirements of the item operation state or the result processing state, which is to be further determined. A specific division principle is to determine whether the operation on the game item is completed. If the operation is not completed, the requirement of the item operation state is satisfied. If the operation is completed, the requirement of the result processing state is satisfied.

Optionally, the state information of the game item may include a quantity of game items. Therefore, it may be determined according to the quantity of the game items whether the condition of the item operation state is satisfied or the condition of the result processing state is satisfied. That is, if the quantity of the game items in the item operation region is less than a preset quantity threshold, identifier information of the game item is recognized and stored, and the game is switched to the item operation state. The quantity threshold is preset according to a game rule. For example, in a desktop card game, two cards or three cards need to be dealt to each of two parties before a game result can be acquired. Therefore, the quantity threshold may be set to 4. If the quantity of the game items is less than 4, the game result cannot be acquired, and an operator needs to further deal cards. Therefore, the game is switched to the item operation state,

If the quantity of the game items in the item operation region is greater than or equal to the preset quantity threshold, it further needs to be determined whether to switch to the item operation state or the result processing state. The reference for determination may be state information of an identification surface in the state information of the game item. If the quantity of the game items in the item operation region is greater than or equal to the preset quantity threshold, for each game item in the game items in the item operation region, it may be determined according to the state information of the identification surface of each of the game items that the identification surface of each of the game items is a visible state or a hidden state.

Therefore, if the identification surface of each of the game items is in the visible state, the identifier information of each of the game items in the visible state is acquired. If it is determined according to the identifier information that a game result has been generated, the game is switched to the result processing state. If the identification surface of at least one game item in the game items is in the hidden state, the game is switched to the item operation state. A desktop card game is used as an example. The item operation region includes a first subregion and a second subregion when two playing cards separately exist in the first subregion and the second subregion. The face of each card is in the visible state. A result in each subregion may be determined according to suits and card values of playing cards in the two subregions.

A target game state is determined by using the quantity, which is able to make a game rule be inserted into logic of switching the state of the game, so that the switching of the state of the game better meets a game rule and is more accurate, thereby reducing the difficulty of manipulation of an operator, and improving the game fun of players. In addition, it is further determined by using a state of the identification surface whether the game result can be acquired, that is, it is determined whether the target game state is the item operation state or the result processing state, which better conforms to a game rule, thereby further improving the accuracy of switching of the state of the game.

It should be noted that the item operation region includes at least two item subregions. When an operator operates a game item, the player performs an operation separately in each item subregion. The operator needs to follow an operation specification determined by a game rule. Therefore, the game items in the subregions satisfy preset relationships corresponding to specifications. A desktop card game is used as an example. The item operation region includes two subregions. The dealer needs to alternately deal cards in the two subregions. Therefore, the quantities of items in the two subregions are the same or are different by 1.

Based on this, according to the states of the desktop elements in the respective subregions of the item operation region, it may be respectively acquired whether a game item exists in each subregion and a quantity of the game items. If quantities of game items in a plurality of item subregions of the item operation region do not satisfy a preset relationship, the state of the game is kept unchanged, and the paused state is kept. If the quantities of the game items in the subregions do not satisfy the preset relationship, it indicates that operations on the game items may fail to meet the specifications. Therefore, the game continues to be kept in the paused state. A desktop card game continues to be used as an example. When the quantities of playing cards in the two subregions are different by 2, it indicates that the card dealing process does not meet the specification. Therefore, the game continues to be kept in the paused state.

Through the relationship between the quantities of the game items in the item subregions, it can be further examined whether the state of the game item meets a game rule such as an operation specification, so that a misoperation of an operator can be avoided, thereby further improving the accuracy of switching of the state of the game, and cheating or the like can be avoided to a particular degree.

Through the detection of the states of the desktop elements in the marker placement region and the item operation region, it may be acquired whether a preset marker exists in the marker placement region and whether a game item exists in the item operation region, so that it may be determined according to a detection result whether an error caused by a misoperation exists. If no error exists, it indicates that the error caused by the misoperation has been eliminated, that is, the normal state is restored. Therefore, a corresponding normal state may be restored. Based on the state switching condition corresponding to the current state, reference for the states of the preset marker and the game item is further added, thereby improving the accuracy of controlling game states.

In this embodiment, based on the state switching condition corresponding to the current state, the detection of the state information of the desktop elements such as the preset marker and the game item is further added. Through the state information acquired through detection, a target game state is determined, thereby improving the accuracy of controlling game states.

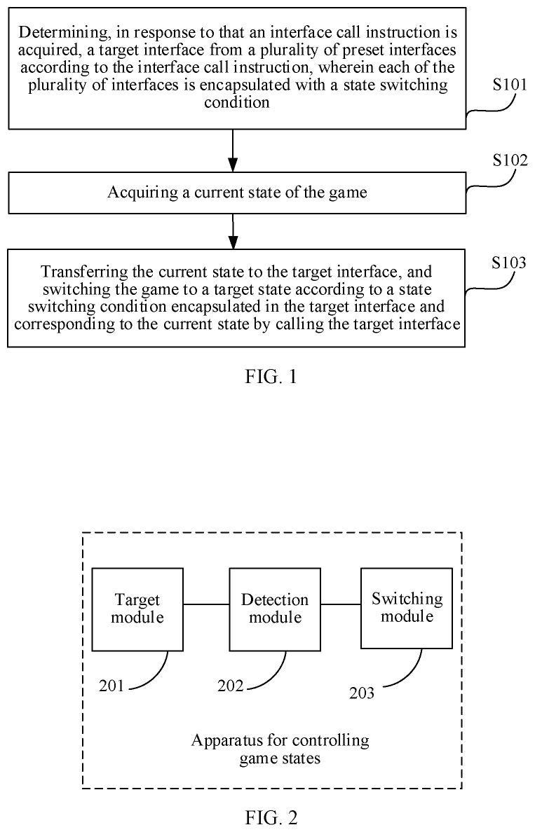

According to a second aspect of the embodiments of the present disclosure, an apparatus for controlling game states is provided. FIG. 2 shows the structure of the apparatus, including:

a target module 201, configured to: determine, in response to that an interface call instruction is acquired, a target interface from a plurality of preset interfaces according to the interface call instruction, wherein each of the plurality of interfaces is encapsulated with a state switching condition;

a state module 202, configured to acquire a current state of the game; and

a switching module 203, configured to: transfer the current state to the target interface, switch the game to a target state according to a state switching condition encapsulated in the target interface and corresponding to the current state by calling the target interface.

In some embodiments of the disclosure, the apparatus further includes:

an image module, configured to acquire a desktop image of the game in the current state;

a detection module, configured to detect state information of a desktop element of the game according to the desktop image; and

a transfer module, configured to transfer the state information to the target interface; and

when the switching module is configured to switch the game to the target state according to a state switching condition encapsulated in the target interface and corresponding to the current state by calling the target interface, the switching module is specifically configured to:

switch the game to a target state according to the state switching condition encapsulated in the target interface and corresponding to the current state together with the state information.

In some embodiments of the disclosure, the desktop element includes a marker placement region and an item operation region, the marker placement region is used for placing a preset marker before the game is started, and the item operation region is used for operating a game item if the game is in an item operation state;

when the target module is configured to determine the target interface from the plurality of preset interfaces according to the interface call instruction, the target interface is specifically configured to:

if the interface call instruction is used for instructing to invalidate a current game and start a next round of game, determine that the target interface is an invalidation interface; and

when the switching module is configured to switch the game to a target state according to the state switching condition encapsulated in the target interface and corresponding to the current state together with the state information, the switching module is specifically configured to:

if the target interface is the invalidation interface and the current state is a paused state, determine, according to the state information, whether the preset marker exists in the marker placement region and whether the item operation region is in an empty state; and

if the preset marker exists in the marker placement region and the item operation region is in the empty state, switch the game to a prop operation state.

In some embodiments of the disclosure, the desktop element includes a marker placement region, an item operation region, and a game item, the marker placement region is used for placing a preset marker before the game is started, and the game item operation region is used for operating the game item if the game is in an item operation state;

when the target module is configured to determine the target interface from the plurality of preset interfaces according to the interface call instruction, the target module is specifically configured to:

if the interface call instruction is used for instructing to restore a prop operation state, the item operation state, or a result processing state of a current round of game, determine that the target interface is a reset interface; and

when the switching module is configured to switch the game to a target state according to the state switching condition encapsulated in the target interface and corresponding to the current state together with the state information, the switching module is specifically configured to:

if the target interface is the reset interface and the current state is a paused state, determine, according to the state information, whether the preset marker exists in the marker placement region and whether the item operation region is in an empty state; and

if the preset marker exists in the marker placement region and the item operation region is in the empty state, switch the game to the prop operation state; and

if the preset marker exists in the marker placement region and the game item exists in the item operation region, switch the game to the item operation state or the result processing state according to state information of the game item in the item operation region.

In some embodiments of the disclosure, the state information of the game item includes a quantity of the game items; and

when the switching module is configured to switch the game to the item operation state or the result processing state according to state information of the game item in the item operation region, the switching module is specifically configured to:

if the quantity of the game items in the item operation region is less than a preset quantity threshold, switch the game to the item operation state.

In some embodiments of the disclosure, the state information of the game item further includes state information of an identification surface of the game item; and

when the switching module is configured to switch the game to the item operation state or the result processing state according to state information of the game item in the item operation region, the switching module is specifically configured to:

if the quantity of the game items is greater than or equal to the preset quantity threshold, for each of the game items in the plurality of game items in the item operation region, determine, according to the state information of the identification surface of each of the game items, that the identification surface of each of the game identifiers object is a visible state or a hidden state;

if the identification surface of each of the game items is in the visible state, acquire the identifier information of each of the game identifiers object in the visible state, and if it is determined according to the identifier information that a game result has been generated, switch the game to the result processing state; and

if the identification surface of at least one game item in the plurality of game items is in the hidden state, switch the game to the item operation state.

In some embodiments of the disclosure, the item operation region includes at least two item subregions;

when the switching module is configured to determine, according to the state information, whether the item operation region is in an empty state, the switching module is specifically configured to:

determine, according to the state information, whether each item subregion of the item operation region is in the empty state; and

when the switching module is configured to switch the game to target state according to the state switching condition encapsulated in the target interface and corresponding to the current state together with the state information, the switching module is further specifically configured to:

if a relationship between quantities of items in a plurality of item subregions of the item operation region do not satisfy a preset relationship, keep the game in the paused state.

In some embodiments of the disclosure, when the target module is configured to determine the target interface from the plurality of preset interfaces according to the interface call instruction, the target module is specifically configured to:

if the interface call instruction is used for instructing to end the game, determine that the target interface is an idle interface;

if the interface call instruction is used for instructing to start a round of game, determine that the target interface is a prop interface;

if the interface call instruction is used for instructing to pause the game, determine that the target interface is a pause interface; and

if the interface call instruction is used for instructing to reset the game, determine that the target interface is a resetting interface; and

when the switching module is configured to switch the game to a target state according to a state switching condition encapsulated in the target interface and corresponding to the current state by calling the target interface, the switching module is specifically configured to:

if the target interface is the idle interface and the current state is a prop operation state, switch the game to an idle state;

if the target interface is the prop interface and the current state is the idle state, switch the game to the prop operation state;

if the target interface is the pause interface and the current state is the prop operation state or an item operation state, switch the game to a paused state;

if the target interface is the resetting interface and the current state is in any state, switch the game to the idle state; and

if the target interface is any interface and the current state is in a blank state, switch the game to the idle state.

For the apparatus in the foregoing embodiments, a specific manner in which each module performs an operation is already described in detail in the embodiments related to the method in the first aspect, and details are not described herein again.

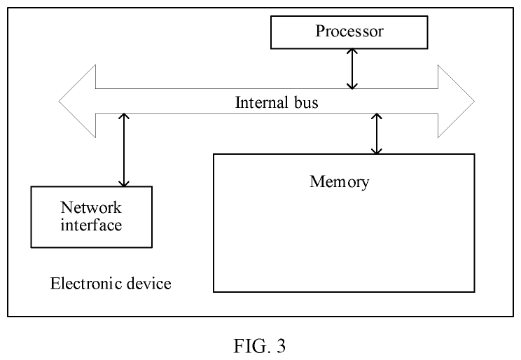

According to a third aspect, at least one embodiment of the present disclosure provides a device. FIG. 3 shows the structure of the device. The device includes a memory and a processor. The memory is configured to store computer instructions capable of being run on the processor, and the processor is configured to switch a state of a game based on any method in the first aspect when executing the computer instructions.

According to a fourth aspect, at least one embodiment of the present disclosure provides a computer readable storage medium, storing a computer program. When executed by a processor, the program implements any method according to the first aspect.

In the present disclosure, the terms “first” and “second” are used for the purpose of description only and are not to be construed as indicating or implying relative importance. The term “plurality” in this specification means two or more, unless otherwise particularly defined.

A person skilled in the art upon consideration of the specification and practice of the present disclosure disclosed herein will readily appreciate other implementations of the present disclosure. The present disclosure is intended to cover any variations, uses, or adaptations of the present disclosure, and the variations, uses, and adaptations follow a general principle of the present disclosure and include common sense or common technical means in this technical field that are not disclosed in the present disclosure. The specification and the embodiments are considered as merely exemplary, and the real scope and spirit of the present disclosure are pointed out in the following claims.

It should be understood that the present disclosure is not limited to the precise structures described above and shown in the accompanying drawings, and various modifications and changes can be made without departing from the scope of the present disclosure. The scope of the present disclosure is limited only by the appended claims.

1. A method of controlling game states, comprising:
determining, in response to that an interface call instruction is acquired, a target interface from a plurality of preset interfaces according to the interface call instruction, wherein each of the plurality of interfaces is encapsulated with a state switching condition;
acquiring a current state of the game; and
transferring the current state to the target interface, and
switching the game to a target state according to a state switching condition encapsulated in the target interface and corresponding to the current state by calling the target interface.

2. The method according to claim 1, wherein
the method further comprises:
acquiring a desktop image of the game in the current state;
detecting state information of one or more desktop elements of the game according to the desktop image; and
transferring the state information to the target interface; and
switching the game to a target state according to a state switching condition encapsulated in the target interface and corresponding to the current state by calling the target interface comprises:
switching the game to a target state according to the state switching condition encapsulated in the target interface and corresponding to the current state together with the state information.

3. The method according to claim 2, wherein
the desktop elements comprise:
a marker placement region for placing a preset marker before the game is started, and
an item operation region for operating a game item if the game is in an item operation state;
determining the target interface from the plurality of preset interfaces according to the interface call instruction comprises:
determining, if the interface call instruction is used for instructing to invalidate a current round of the game and start a next round of the game, that the target interface is an invalidation interface; and
switching the game to a target state according to the state switching condition encapsulated in the target interface and corresponding to the current state together with the state information comprises:
determining, if the target interface is the invalidation interface and the current state is a paused state, whether the preset marker exists in the marker placement region and whether the item operation region is in an empty state according to the state information; and
switching, if the preset marker exists in the marker placement region and the item operation region is in the empty state, the game to a prop operation state.

4. The method according to claim 2, wherein
the desktop elements comprise:
a game item,
a marker placement region for placing a preset marker before the game is started, and
a game item operation region for operating the game item if the game is in an item operation state;
determining the target interface from the plurality of preset interfaces according to the interface call instruction comprises:
determining, if the interface call instruction is used for instructing to restore a prop operation state, an item operation state, or a result processing state of a current round of the game, that the target interface is a restoration interface; and
switching the game to a target state according to the state switching condition encapsulated in the target interface and corresponding to the current state together with the state information comprises:
determining, if the target interface is the restoration interface and the current state is a paused state, whether the preset marker exists in the marker placement region and whether the item operation region is in an empty state according to the state information;
switching, if the preset marker exists in the marker placement region and the item operation region is in the empty state, the game to the prop operation state; and
switching, if the preset marker exists in the marker placement region and the game item exists in the item operation region, the game to the item operation state or the result processing state according to state information of the game item in the item operation region.

5. The method according to claim 4, wherein the state information of the game item comprises a quantity of the game items; and switching the game to the item operation state or the result processing state according to state information of the game item in the item operation region comprises:
switching, if the quantity of the game items in the item operation region is less than a preset quantity threshold, the game to the item operation state.

6. The method according to claim 5, wherein the state information of the game item further comprises state information of an identification surface of the game item; and switching the game to the item operation state or the result processing state according to state information of the game item in the item operation region further comprises:
determining, if the quantity of the game items is greater than or equal to the preset quantity threshold, whether the identification surface of each of the game items in the item operation region is a visible state or a hidden state according to the state information of the identification surface of each of the game items in the item operation region;
if the identification surface of each of the game items is in the visible state,
acquiring the identifier information of each of the game items, and
switching, if a game result is generated according to the identifier information, the game to the result processing state; and
switching, if the identification surface of at least one of the game items is in the hidden state, the game to the item operation state.

7. The method according to claim 4, wherein
the item operation region comprises at least two item subregions;
determining, according to the state information, whether the item operation region is in an empty state comprises:
determining, according to the state information, whether each of the item subregions of the item operation region is in the empty state; and
switching the game to a target state according to the state switching condition encapsulated in the target interface and corresponding to the current state together with the state information further comprises:
keeping, if a relationship between quantities of items in the item subregions of the item operation region does not satisfy a preset relationship, the game in the paused state.

8. The method according to claim 1, wherein determining the target interface from the plurality of preset interfaces according to the interface call instruction comprises:
if the interface call instruction is used for instructing to end the game, determining that the target interface is an idle interface;
if the interface call instruction is used for instructing to start a round of game, determining that the target interface is a prop interface;
if the interface call instruction is used for instructing to pause the game, determining that the target interface is a pause interface; and
if the interface call instruction is used for instructing to reset the game, determining that the target interface is a resetting interface.

9. The method according to claim 8, wherein switching the game to a target state according to a state switching condition encapsulated in the target interface and corresponding to the current state by calling the target interface comprises:
if the target interface is the idle interface and the current state is a prop operation state, switching the game to an idle state;
if the target interface is the prop interface and the current state is the idle state, switching the game to the prop operation state;
if the target interface is the pause interface and the current state is the prop operation state or an item operation state, switching the game to a paused state;
if the target interface is the resetting interface and the current state is in any state, switching the game to the idle state; and
if the target interface is any interface and the current state is in a blank state, switching the game to the idle state.

10.-21. (canceled)

22. An electronic device, comprising a memory and a processor, wherein the memory is configured to store computer instructions capable of being run on the processor, and the processor implements a method for controlling game states when executing the computer instructions, the method comprising:
determining, in response to that an interface call instruction is acquired, a target interface from a plurality of preset interfaces according to the interface call instruction, wherein each of the plurality of interfaces is encapsulated with a state switching condition;
acquiring a current state of the game; and
transferring the current state to the target interface, and
switching the game to a target state according to a state switching condition encapsulated in the target interface and corresponding to the current state by calling the target interface.

23. The electronic device according to claim 22, wherein
the method further comprises:
acquiring a desktop image of the game in the current state;
detecting state information of one or more desktop elements of the game according to the desktop image; and
transferring the state information to the target interface; and
switching the game to a target state according to a state switching condition encapsulated in the target interface and corresponding to the current state by calling the target interface comprises:
switching the game to a target state according to the state switching condition encapsulated in the target interface and corresponding to the current state together with the state information.

24. The electronic device according to claim 23, wherein
the desktop elements comprise:
a marker placement region for placing a preset marker before the game is started, and
an item operation region for operating a game item if the game is in an item operation state;
determining the target interface from the plurality of preset interfaces according to the interface call instruction comprises:
determining, if the interface call instruction is used for instructing to invalidate a current round of the game and start a next round of the game, that the target interface is an invalidation interface; and
switching the game to a target state according to the state switching condition encapsulated in the target interface and corresponding to the current state together with the state information comprises:
determining, if the target interface is the invalidation interface and the current state is a paused state, whether the preset marker exists in the marker placement region and whether the item operation region is in an empty state according to the state information; and
switching, if the preset marker exists in the marker placement region and the item operation region is in the empty state, the game to a prop operation state.

25. The electronic device according to claim 23, wherein
the desktop elements comprise:
a game item,
a marker placement region for placing a preset marker before the game is started, and
a game item operation region for operating the game item if the game is in an item operation state;
determining the target interface from the plurality of preset interfaces according to the interface call instruction comprises:
determining, if the interface call instruction is used for instructing to restore a prop operation state, an item operation state, or a result processing state of a current round of the game, that the target interface is a restoration interface; and
switching the game to a target state according to the state switching condition encapsulated in the target interface and corresponding to the current state together with the state information comprises:
determining, if the target interface is the restoration interface and the current state is a paused state, whether the preset marker exists in the marker placement region and whether the item operation region is in an empty state according to the state information;
switching, if the preset marker exists in the marker placement region and the item operation region is in the empty state, the game to the prop operation state; and
switching, if the preset marker exists in the marker placement region and the game item exists in the item operation region, the game to the item operation state or the result processing state according to state information of the game item in the item operation region.

26. The electronic device according to claim 25, wherein the state information of the game item comprises a quantity of the game items; and switching the game to the item operation state or the result processing state according to state information of the game item in the item operation region comprises:
switching, if the quantity of the game items in the item operation region is less than a preset quantity threshold, the game to the item operation state.

27. The electronic device according to claim 26, wherein the state information of the game item further comprises state information of an identification surface of the game item; and switching the game to the item operation state or the result processing state according to state information of the game item in the item operation region further comprises:
determining, if the quantity of the game items is greater than or equal to the preset quantity threshold, whether the identification surface of each of the game items in the item operation region is a visible state or a hidden state according to the state information of the identification surface of each of the game items in the item operation region;
if the identification surface of each of the game items is in the visible state,
acquiring the identifier information of each of the game items, and
switching, if a game result is generated according to the identifier information, the game to the result processing state; and
switching, if the identification surface of at least one of the game items is in the hidden state, the game to the item operation state.

28. The electronic device according to claim 25, wherein
the item operation region comprises at least two item subregions;
determining, according to the state information, whether the item operation region is in an empty state comprises:
determining, according to the state information, whether each of the item subregions of the item operation region is in the empty state; and
switching the game to a target state according to the state switching condition encapsulated in the target interface and corresponding to the current state together with the state information further comprises:
keeping, if a relationship between quantities of items in the item subregions of the item operation region does not satisfy a preset relationship, the game in the paused state.

29. The electronic device according to claim 22, wherein determining the target interface from the plurality of preset interfaces according to the interface call instruction comprises:
if the interface call instruction is used for instructing to end the game, determining that the target interface is an idle interface;
if the interface call instruction is used for instructing to start a round of game, determining that the target interface is a prop interface;
if the interface call instruction is used for instructing to pause the game, determining that the target interface is a pause interface; and
if the interface call instruction is used for instructing to reset the game, determining that the target interface is a resetting interface.

30. The method according to claim 29, wherein switching the game to a target state according to a state switching condition encapsulated in the target interface and corresponding to the current state by calling the target interface comprises:
if the target interface is the idle interface and the current state is a prop operation state, switching the game to an idle state;
if the target interface is the prop interface and the current state is the idle state, switching the game to the prop operation state;
if the target interface is the pause interface and the current state is the prop operation state or an item operation state, switching the game to a paused state;
if the target interface is the resetting interface and the current state is in any state, switching the game to the idle state; and
if the target interface is any interface and the current state is in a blank state, switching the game to the idle state.

31. A computer-readable storage medium, storing a computer program, wherein a method for controlling game states is performed when the program is executed by a processor, the method comprising:
determining, in response to that an interface call instruction is acquired, a target interface from a plurality of preset interfaces according to the interface call instruction, wherein each of the plurality of interfaces is encapsulated with a state switching condition;
acquiring a current state of the game; and
transferring the current state to the target interface, and
switching the game to a target state according to a state switching condition encapsulated in the target interface and corresponding to the current state by calling the target interface.
